(19) United States
(12) Patent Application Publication
(10) Pub. No.: US 2016/0200973 A1
(43) Pub. Date: Jul. 14, 2016

(54) PHOSPHORS

(71) Applicant: MERCK PATENT GMBH, Darmstadt (DE)

(72) Inventors: Holger WINKLER, Darmstadt (DE); Ralf PETRY, Griesheim (DE); Tim VOSGROENE, Ober-Ramstadt (DE); Christof HAMPEL, Frankfurt am Main (DE); Andreas BENKER, Lautertal (DE)

(73) Assignee: Merck Patent GmbH, Darmstadt (DE)

(21) Appl. No.: 14/654,182

(22) PCT Filed: Dec. 2, 2013
(86) PCT No.: PCT/EP2013/003630

§ 371 Date: Jun. 19, 2015

(30) Foreign Application Priority Data
Dec. 21, 2012 (EP) 12008530.3

(51) Int. Cl. C09K 11/77; F21K 99/00; F21V 9/16

(52) U.S. Cl. CPC C09K 11/7792; C09K 11/7721; F21V 9/16; F21K 9/56

(57) ABSTRACT

The invention relates to compounds containing an anionic skeleton structure, dopants and cations, where
a. the anionic skeleton structure is characterised by coordination tetrahedra GL₄_{^{−}}, where G stands for silicon, and L stands for N and O,
b. the cations are selected from the alkaline-earth metals,
c. the dopant present is trivalent cerium or a mixture of trivalent cerium and divalent europium,
d. the charge compensation of the cerium doping takes place i) via corresponding replacement of alkaline-earth metal cations by alkali-metal cations and/or ii) via a corresponding increase in the nitrogen content and/or iii) via a corresponding reduction in the cations,
   to a process for the preparation of these compounds, and to the use thereof as conversion phosphors.

The present invention relates to novel compounds, to a process for the preparation thereof and to the use thereof as conversion phosphors. The present invention also relates to an emission-converting material comprising at least the conversion phosphor according to the invention and to the use thereof in light sources, in particular so-called pc-LEDs (phosphor converted light emitting devices). The present invention furthermore relates to light sources, in particular pc-LEDs, and lighting units which contain a primary light source and the emission-converting material according to the invention.

For more than 100 years, inorganic phosphors have been developed in order to adapt the spectra of emissive display screens, X-ray amplifiers and radiation or light sources in such a way that they meet the requirements of the respective area of application in as optimal a manner as possible and at the same time consume as little energy as possible. The type of excitation, i.e. the nature of the primary radiation source and the requisite emission spectrum, is of crucial importance here for the choice of host lattice and the activators.

In particular for fluorescent light sources for general lighting, i.e. for low-pressure discharge lamps and light-emitting diodes, novel phosphors are constantly being developed in order further to increase the energy efficiency, colour reproduction and stability.

There are in principle three different approaches to obtaining white-emitting inorganic LEDs (light emitting diodes) by additive colour mixing:
(1) The so-called RGB LEDs (red+green+blue LEDs), in which white light is generated by mixing the light from three different light-emitting diodes which emit in the red, green and blue spectral region.
(2) The UV LED+RGB phosphor systems, in which a semiconductor emitting in the UV region (primary light source) emits the light to the environment, in which three different phosphors (conversion phosphors) are stimulated to emit in the red, green and blue spectral region.
(3) So-called complementary systems, in which an emitting semiconductor (primary light source) emits, for example, blue light, which stimulates one or more phosphors (conversion phosphors) to emit light, for example in the yellow region. By mixing the blue and yellow light, white light, for example, is then produced.

Binary complementary systems have the advantage that they are capable of producing white light with only one primary light source and—in the simplest case—with only one conversion phosphor. The best-known of these systems consists of an indium aluminium nitride chip as primary light source, which emits light in the blue spectral region, and a cerium-doped yttrium aluminium garnet (YAG:Ce) as conversion phosphor, which is stimulated in the blue region and emits light in the yellow spectral region. However, improvements in the colour rendering index and the stability of the colour temperature are desirable.

On use of a blue-emitting semiconductor as primary light source, these so-called binary complementary systems thus require a yellow conversion phosphor or green- and red-emitting conversion phosphors in order to reproduce white light. If, as an alternative, the primary light source used is a semiconductor which emits in the violet spectral region or in the near-UV spectrum, either an RGB phosphor mixture or a dichromatic mixture of two complementary light-emitting conversion phosphors must be used in order to obtain white light.

On use of a system having a primary light source in the violet or UV region and two complementary conversion phosphors, light-emitting diodes having a particularly high lumen equivalent can be provided. A further advantage of a dichromatic phosphor mixture is the lower spectral interaction and the associated higher package gain.

In particular, inorganic fluorescent powders which can be excited in the blue and/or UV region of the spectrum are therefore gaining ever-greater importance today as conversion phosphors for light sources, in particular for pc-LEDs.

In the meantime, many conversion phosphors have been disclosed, for example alkaline-earth metal orthosilicates, thiogallates, garnets and nitrides, each of which are doped with Ce³⁺ or Eu²⁺.

However, there is a constant demand for novel conversion phosphors which can be excited in the blue or UV region and then emit light in the visible region, in particular in the green spectral region.

A first embodiment of the present invention is therefore a compound containing an anionic skeleton structure, dopants and cations, where
a. the anionic skeleton structure is characterised by coordination tetrahedra GL₄_{^{−}}, where G stands for silicon, which may be partly replaced by C, Ge, B, Al or In, and L stands for N and O, with the proviso that N makes up at least 60 atom-% of L,
b. the cations are selected from the alkaline-earth metals, with the proviso that strontium and barium together make up 50 atom-% of the cations or more,
c. the dopant present is trivalent cerium or a mixture of trivalent cerium and divalent europium,
d. the charge compensation of the cerium doping takes place i) via corresponding replacement of alkaline-earth metal cations by alkali-metal cations and/or ii) via a corresponding increase in the nitrogen content and/or iii) via a corresponding reduction in the alkaline-earth metal cations.

The term anionic skeleton structure here relates to the structure motif in the composition, in which G is generally present in coordination tetrahedra. These tetrahedra may be linked to one another via one or more common L atoms and thus form extended anionic partial structural elements in the solid. Corresponding structure motifs are usually detected using crystallographic methods for structure determination or also via spectroscopic methods and are well known to the person skilled in the art, in particular from silicate chemistry.

In general, the determination of the structure of inorganic solid materials is carried out on the basis of a combination of crystallographic data, optionally spectroscopic data and of information on the elemental composition, which, in the case of quantitative reaction, can either arise from the composition of the starting materials or alternatively is determined by methods of elemental analysis. Corresponding methods are well established in chemical analysis and can therefore be presumed to be known to the person skilled in the art. Amount data in atom-% relate to numerical ratios of atoms of certain chemical elements to larger groups which can usually occupy the same lattice sites in crystal structure, such as, for example, nitrogen and oxygen as L.

The compounds according to the invention can usually be excited in the blue spectral region, preferably at about 450 nm, and usually emit in the green spectral region. The compounds according to the invention otherwise have properties comparable to the 2-5-8 nitrides, where these make significantly lower requirements of the preparation processes with respect to oxygen content and phase purity or have lower sensitivity to moisture.

In the context of this application, emission in the red region or red light denotes light whose intensity maximum is at a wavelength between 600 nm and 670 nm; correspondingly, green or emission in the green region denotes light whose maximum is at a wavelength between 508 nm and 550 nm, and yellow denotes light whose maximum is at a wavelength between 551 nm and 599 nm.

In a preferred variant of the invention, the alkaline-earth metal cations are strontium, magnesium, calcium and/or barium, where in one embodiment essentially only strontium and barium are present, and in the same or an alternative embodiment strontium makes up more than 50 atom-% of the alkaline-earth metal cations, and in the same or a further alternative embodiment barium makes up from 40 atom-% to 50 atom-% of the alkaline-earth metal cations.

In the same or another variant of the invention, G stands for more than 80 atom-% of silicon or for more than 90 atom-% of silicon. It may also be preferred in accordance with the invention for G to be formed by silicon. Alternatively, it may be preferred for silicon to have been partly replaced by C or Ge.

In particular, the compound according to the invention can be a compound of the formula Ia,

A_{2-0.5y-x+1.5z}M_{0.5x}Ce_{0.5x}G₅N_{8-y+z}O_{y} (Ia)

where
A stands for one or more elements selected from Ca, Sr, Ba, Mg,
M stands for one or more elements selected from Li, Na, K,
G stands for Si, which may be partly replaced by C, Ge, B, Al or In,
x stands for a value from the range from 0.005 to 1 and
y stands for a value from the range from 0.01 to 3 and
z stands for a value from the range from 0 to 3.

Alternatively, the compound according to the invention can be a compound of the formula Ib,

A_{2-0.5y-0.75x+1.5z}Ce_{0.5x}G₅N_{8-y+z}O_{y} (Ib)

where
A stands for one or more elements selected from Ca, Sr, Ba, Mg,
M stands for one or more elements selected from Li, Na, K,
G stands for Si, which may be partly replaced by C, Ge, B, Al or In,
x stands for a value from the range from 0.005 to 1 and
y stands for a value from the range from 0.01 to 3 and
z stands for a value from the range from 0 to 3.

Again alternatively, the compound according to the invention can be a compound of the formula Ic,

A_{2-0.5y+1.5z}Ce_{0.5x}G₅N_{8+0.5x-y+z}O_{y} (Ic)

where
A stands for one or more elements selected from Ca, Sr, Ba, Mg,
M stands for one or more elements selected from Li, Na, K,
G stands for Si, which may be partly replaced by C, Ge, B, Al or In,
x stands for a value from the range from 0.005 to 1 and
y stands for a value from the range from 0.01 to 3 and
z stands for a value from the range from 0 to 3.

In the said compounds of the formulae Ia, Ib and Ic, it may be desired for x to stand for a value from the range from 0.01 to 0.8, alternatively from the range 0.02 to 0.7 and furthermore alternatively from the range 0.05 to 0.6.

At the same time or alternatively, it may be desired for y to stand for a value from the range from 0.1 to 2.5, preferably from the range 0.2 to 2 and especially preferably from the range 0.22 to 1.8.

At the same time or alternatively, it may be desired for z to stand for the value 0, or a value from the range from 0.1 to 2.5, preferably from the range 0.2 to 2 and especially preferably from the range 0.22 to 1.8.

It has proven essential in accordance with the invention for cerium to be present as dopant. In various variants of the invention, cerium can be the only dopant or can be used in combination with further dopants. Dopants which can be used in this case are conventional divalent or trivalent rare-earth ions or sub-group metal ions. In one variant, it is preferred for europium to be present in the dopant alongside cerium. In this variant, it has been shown that the stability is increased if the cations contain a proportion of barium, so this combination may be a preferred combination.

The compound here may be in the form of a pure substance or a mixture. The present invention therefore furthermore relates to a mixture comprising at least one compound, as defined above, and at least one further silicon- and oxygen-containing compound.

In mixtures of this type, the compound is usually present in a proportion by weight from the range 30-95% by weight, preferably from the range 50-90% by weight and especially preferably from the range 60-88% by weight.

In preferred embodiments of the invention, the at least one silicon- and oxygen-containing compound comprises x-ray-amorphous or glass-like phases which are distinguished by a high silicon and oxygen content, but may also contain metals, in particular alkaline-earth metals, such as strontium. It may in turn be preferred for these phases to fully or partly surround the particles of the compound.

It is preferred in accordance with the invention for the at least one further silicon- and oxygen-containing compound to be a reaction by-product of the preparation of the compound and for this to not adversely affect the application-relevant optical properties of the compound.

The invention therefore furthermore relates to a mixture comprising a compound of the formula I which is obtainable by a process in which, in a step a), suitable starting materials selected from binary nitrides, halides and oxides or corresponding reactive forms thereto are mixed, and, in a step b), the mixture is thermally treated under reductive conditions.

The invention furthermore relates to the corresponding process for the preparation of the compounds and to the use according to the invention of the compounds as phosphor or conversion phosphor, in particular for the partial or complete conversion of the blue or near-UV emission from a primary light source, preferably a luminescent diode or a laser.

The compounds according to the invention are also referred to below as phosphors.

Compounds according to the invention give rise to good LED qualities even when employed in small amounts. The LED quality is described here via conventional parameters, such as, for example, the colour rendering index, the correlated colour temperature, lumen equivalent or absolute lumen, or the colour point in CIE x and CIE y coordinates.

The colour rendering index or CRI is a dimensionless lighting quantity, familiar to the person skilled in the art, which compares the colour reproduction faithfulness of an artificial light source with that of sunlight or filament light sources (the latter two have a CRI of 100).

The CCT or correlated colour temperature is a lighting quantity, familiar to the person skilled in the art, with the unit kelvin. The higher the numerical value, the colder the white light from an artificial radiation source appears to the observer. The CCT follows the concept of the black body radiator, whose colour temperature follows a Planck curve in the CIE diagram.

The lumen equivalent is a lighting quantity, familiar to the person skilled in the art, with the unit lm/W which describes the magnitude of the photometric luminous flux in lumens of a light source at a certain radiometric radiation power with the unit watt. The higher the lumen equivalent, the more efficient a light source.

The lumen is a photometric lighting quantity, familiar to the person skilled in the art, which describes the luminous flux of a light source, which is a measure of the total visible radiation emitted by a radiation source. The greater the luminous flux, the brighter the light source appears to the observer.

CIE x and CIE y stand for the coordinates in the standard CIE colour chart (here standard observer 1931), familiar to the person skilled in the art, by means of which the colour of a light source is described.

All the quantities mentioned above are calculated from emission spectra of the light source by methods familiar to the person skilled in the art.

In addition, the excitability of the phosphors according to the invention extends over a broad range, which extends from about 410 nm to 530 nm, preferably 430 nm to about 500 nm.

Furthermore advantageous in the case of the phosphors according to the invention is the stability to moisture and water vapour, which may enter the LED package via diffusion processes from the environment and may thus reach the surface of the phosphor, and the stability to acidic media, which may arise as by-products in the curing of the binder in the LED package or as additives in the LED package. Phosphors which are preferred in accordance with the invention have stabilities which are higher than the nitridic phosphors which are usual to date.

The phosphors according to the invention can be prepared analogously to previously known processes for the preparation of undoped or Eu-doped nitrides and oxynitrides, where the person skilled in the art is presented with no difficulties in replacing the respective Eu source by a corresponding cerium source. Known processes for the preparation of M₂Si₅N₈:Eu are, for example:

(2-x)M+xEu+5Si(NH₂)→M₂₋ₓEuₓSi₅N₈+5H₂ (1)
(Schnick et al., Journal of Physics and Chemistry of Solids (2000), 61(12), 2001-2006)

(2-x)M₃N₂+3xEuN+5Si₃N₄→3M₂₋ₓEuₓSi₅N₈+0.5xN₂ (2)
(Hintzen et al., Journal of Alloys and Compounds (2006), 417(1-2), 273-279)

(2-x)MO+1.666Si₃N₄+0.5xEu₂O₃+(2+0.5x)C+1.5N₂→M₂₋ₓEuₓSi₅N₈+(2+0.5x)CO (3)
(Piao et al., Applied Physics Letters 2006, 88, 161908)

2Si₃N₄+2(2-x)MCO₃+x/2Eu₂O₃→M₂₋ₓEuₓSi₅N₈+M₂SiO₄+CO₂ (4)
(Xie et al., Chemistry of Materials, 2006, 18, 5578)

(2-x)M+xEu+5SiCl₄+28NH₃→M₂₋ₓEuₓSi₅N₈+20NH₄Cl+2H₂ (5)
(Jansen et al., WO 2010/029184 A1).

Silicooxynitrides are accessible, for example, by stoichiometric mixing of SiO₂, M₃N₂, Si₃N₄ and EuN and subsequent calcination at temperatures of about 1600° C. (for example in accordance with WO 2011/091839).

Of the above processes for the preparation of siliconitrides, process (2) is particularly suitable since the corresponding starting materials are commercially available, no secondary phases are formed in the synthesis, and the efficiency of the materials obtained is high.

In a process according to the invention for the preparation of phosphors according to the invention, suitable starting materials selected from binary nitrides, halides and oxides or corresponding reactive forms thereto are therefore mixed in a step a), and the mixture is, in a step b), thermally treated under non-oxidising conditions.

This process is frequently followed by a second calcination step, which increases the efficiency of the material a little further. In this second calcination step, it may be helpful to add alkaline-earth metal nitride. In a variant of the invention, pre-sintered oxynitride to alkaline-earth metal nitride is employed in the ratio 2:1 to 20:1, in an alternative variant in the ratio 4:1 to 9:1. This post-calcination enables the emission maximum of the target compound to be shifted, so that the specific addition of alkaline-earth metal nitride can be utilised in order to set a desired emission maximum exactly.

The reaction in step b) and also the optional post-calcination are usually carried out at a temperature above 800° C., preferably at a temperature above 1200° C. and especially preferably in the range 1400° C.-1800° C. Usual durations for these steps are 2 to 14 h, alternatively 4 to 12 h and again alternatively 6 to 10 h.

The non-oxidising conditions here are established, for example, using inert gases or carbon monoxide, forming gas or hydrogen or vacuum or oxygen-deficiency atmosphere, preferably in a stream of nitrogen, preferably in a stream of N₂/H₂ and especially preferably in a stream of N₂/H₂/NH₃.

The calcination can be carried out, for example, by introducing the resultant mixtures into a high-temperature oven, for example in a boron nitride vessel. In a preferred embodiment, the high-temperature oven is a tubular furnace which contains a molybdenum foil tray.

After the calcination, the compounds obtained are, in a variant of the invention, treated with acid in order to wash out unreacted alkaline-earth metal nitride. The acid used is preferably hydrochloric acid. The powder obtained here is, for example, suspended in 0.5 molar to 2 molar hydrochloric acid, more preferably 1 molar hydrochloric acid, for 0.5 to 3 h, more preferably 0.5 to 1.5 h, subsequently filtered off and dried at a temperature in the range from 80 to 150° C.

In a further alternative embodiment of the invention, the calcination and workup, which can be carried out as described above by acid treatment, are again followed by a further calcination step. This is preferably carried out in a temperature range from 200 to 400° C., particularly preferably from 250 to 350° C. This further calcination step is preferably carried out under a reducing atmosphere. The duration of this calcination step is usually between 15 minutes and 10 h, preferably between 30 minutes and 2 h.

In still a further embodiment, the compounds obtained by one of the above-mentioned processes according to the invention can be coated. Suitable for this purpose are all coating methods as are known to the person skilled in the art from the prior art and are used for phosphors. Suitable materials for the coating are, in particular, metal oxides and nitrides, in particular alkaline-earth metal oxides, such as Al₂O₃, and alkaline-earth metal nitrides, such as AlN, and SiO₂. The coating can be carried out here, for example, by fluidised-bed methods. Further suitable coating methods are known from JP 04-304290, WO 91/10715, WO 99/27033, US 2007/0298250, WO 2009/065480 and WO 2010/075908.

The present invention furthermore relates to a light source having at least one primary light source which comprises at least one compound according to the invention. The emission maximum of the primary light source here is usually in the range 410 nm to 530 nm, preferably 430 nm to about 500 nm. A range between 440 and 480 nm is especially preferred, where the primary radiation is converted partly or fully into longer-wave radiation by the phosphors according to the invention.

In a preferred embodiment of the light source according to the invention, the primary light source is a luminescent indium aluminium gallium nitride, in particular of the formula InᵢGaⱼAlₖN, where 0≦i, 0≦j, 0≦k, and i+j+k=1.

Possible forms of light sources of this type are known to the person skilled in the art. These can be light-emitting LED chips of various structure.

In a further preferred embodiment of the light source according to the invention, the primary light source is a luminescent arrangement based on ZnO, TCO (transparent conducting oxide), ZnSe or SiC or an arrangement based on an organic light-emitting layer (OLED).

In a further preferred embodiment of the light source according to the invention, the primary light source is a source which exhibits electroluminescence and/or photoluminescence. The primary light source may furthermore also be a plasma or discharge source.

Corresponding light sources according to the invention are also known as light-emitting diodes or LEDs.

The phosphors according to the invention can be employed individually or as a mixture with the following phosphors, which are familiar to the person skilled in the art. Corresponding phosphors which are in principle suitable for mixtures are, for example:

Ba₂SiO₄:Eu²⁺, BaSi₂O₅:Pb²⁺, BaₓSr₁₋ₓF₂:Eu²⁺, BaSrMgSi₂O₇:Eu²⁺, BaTiP₂O₇, (Ba,Ti)₂P₂O₇:Ti, Ba₃WO₆:U, BaY₂F₈:Er³⁺,Yb⁺, Be₂SiO₄:Mn²⁺, Bi₄Ge₃O₁₂, CaAl₂O₄:Ce³⁺, CaLa₄O₇:Ce³⁺, CaAl₂O₄:Eu²⁺, CaAl₂O₄:Mn²⁺, CaAl₄O₇:Pb²⁺,Mn²⁺, CaAl₂O₄:Tb³⁺, Ca₃Al₂Si₃O₁₂:Ce³⁺, Ca₃Al₂Si₃O₁₂:Ce³⁺, Ca₃Al₂Si₃O,₂:Eu²⁺, Ca₂B₅O₉Br:Eu²⁺, Ca₂B₅O₉Cl:Eu²⁺, Ca₂B₅O₉C:Pb²⁺, CaB₂O₄:Mn²⁺, Ca₂B₂O₅:Mn²⁺, CaB₂O₄:Pb²⁺, CaB₂P₂O₉:Eu²⁺, Ca₅B₂SiO₁₀:EU³⁺, Ca_{0.5}Ba_{0.5}Al₁₂O₁₉:Ce³⁺,Mn²⁺, Ca₂Ba₃(PO₄)₃Cl:EU²⁺, CaBr₂:Eu²⁺ in SiO₂, CaCl₂:Eu²⁺ in SiO₂, CaCl₂:Eu²⁺,Mn²⁺ in SiO₂, CaF₂:Ce³⁺, CaF₂:Ce³⁺,Mn²⁺, CaF₂:Ce³⁺,Tb³⁺, CaF₂:Eu²⁺, CaF₂:Mn²⁺, CaF₂:U, CaGa₂O₄:Mn²⁺, CaGa₄O₇:Mn²⁺, CaGa₂S₄:Ce³⁺, CaGa₂S₄:Eu²⁺, CaGa₂S₄:Mn²⁺, CaGa₂S₄:Pb²⁺, CaGeO₃:Mn²⁺, CaI₂:Eu²⁺ in SiO₂, CaI₂:Eu²⁺, Mn²⁺ in SiO₂, CaLaBO₄:Eu³⁺, CaLaB₃O₇:Ce³⁺,Mn²⁺, Ca₂La₂BO_{6.5}:Pb²⁺, Ca₂MgSi₂O₇, Ca₂MgSi₂O₇:Ce³⁺, CaMgSi₂O₆:Eu²⁺, Ca₃MgSi₂O₈:Eu²⁺, Ca₂MgSi₂O₇:Eu²⁺, CaMgSi₂O₆:Eu²⁺,Mn²⁺, Ca₂MgSi₂O₇:Eu²⁺, Mn²⁺, CaMoO₄, CaMoO₄:Eu³⁺, CaO:Bi³⁺, CaO:Cd²⁺, CaO:Cu⁺, CaO:Eu³⁺, CaO:Eu³⁺, Na⁺, CaO:Mn²⁺, CaO:Pb²⁺, CaO:Sb³⁺, CaO:Sm³⁺, CaO:Tb³⁺, CaO:Tl, CaO:Zn²⁺, Ca₂P₂O₇:Ce³⁺, α-Ca₃(PO₄)₂:Ce³⁺, β-Ca₃(PO₄)₂:Ce³⁺, Ca₅(PO₄)₃Cl:EU²⁺, Ca₅(PO₄)₃Cl:Mn²⁺, Ca₅(PO₄)₃Cl:Sb³⁺, Ca₅(PO₄)₃Cl:Sn²⁺, β-Ca₃(PO₄)₂:Eu²⁺,Mn²⁺, Ca₅(PO₄)₃F:Mn²⁺, Caₛ(PO₄)₃F:Sb³⁺, Caₛ(PO₄)₃F:Sn²⁺, α-Ca₃(PO₄)₂:Eu²⁺, β-Ca₃(PO₄)₂:Eu²⁺, Ca₂P₂O₇:Eu²⁺, Ca₂P₂O₇:Eu²⁺, Mn²⁺, CaP₂O₆:Mn²⁺, α-Ca₃(PO₄)₂:Pb²⁺, α-Ca₃(PO₄)₂:Sn²⁺, β-Ca₃(PO₄)₂:Sn²⁺, β-Ca₂P₂O₇:Sn,Mn, α-Ca₃(PO₄)₂:Tr, CaS:Bi³⁺, CaS:Bi³⁺,Na, CaS:Ce³⁺, CaS:Eu²⁺, CaS:Cu⁺,Na⁺, CaS:La³⁺, CaS:Mn²⁺, CaSO₄:Bi, CaSO₄:Ce³⁺, CaSO₄:Ce³⁺, Mn²⁺, CaSO₄:Eu²⁺, CaSO₄:Eu²⁺, Mn²⁺, CaSO₄:Pb²⁺, CaS:Pb²⁺, CaS:Pb²⁺,Cl, CaS:Pb²⁺, Mn²⁺, CaS:Pr³⁺, Pb²⁺,Cl, CaS:Sb³⁺, CaS:Sb³⁺, Na, CaS:Sm³⁺, CaS:Sn²⁺, CaS:Sn²⁺, F, CaS:Tb³⁺, CaS:Tb³⁺,Cl, CaS:Y³⁺, CaS:Yb²⁺, CaS:Yb²⁺,Cl, CaSiO₃:Ce³⁺, Ca₃SiO₄Cl₂:Eu²⁺, Ca₃SiO₄Cl₂:Pb²⁺, CaSiO₃:Eu²⁺, CaSiO₃:Mn²⁺,Pb, CaSiO₃:Pb²⁺, CaSiO₃:Pb²⁺,Mn²⁺, CaSiO₃:Ti⁴⁺, CaSr₂(PO₄)₂:Bi³⁺, β-(Ca,Sr)₃(PO₄)₂:Sn²⁺Mn²⁺, CaTi_{0.9}Al_{0.1}O₃:Bi³⁺, CaTiO₃:Eu³⁺, CaTiO₃:Pr³⁺, Ca₅(VO₄)₃Cl, CaWO₄, CaWO₄:Pb²⁺, CaWO₄:W, Ca₃WO₆:U, CaYAlO₄:Eu³⁺, CaYBO₄:Bi³⁺, CaYBO₄:Eu³⁺, CaYB_{0.8}O_{3.7}:Eu³⁺, CaY₂ZrO₆:Eu³⁺, (Ca,Zn,Mg)₃(PO₄)₂:Sn, CeF₃, (Ce,Mg)BaAl₁₁O₁₈:Ce, (Ce,Mg)SrAl₁₁O₁₈:Ce, CeMgAl₁₁O₁₉:Ce:Tb, Cd₂B₆O₁₁:Mn²⁺, CdS:Ag⁺,Cr, CdS:In, CdS:In, CdS:In,Te, CdS:Te, CdWO₄, CsF, CsI, CsI:Na⁺, CsI:Tl, (ErCl₃)_{0.25}(BaCl₂)_{0.75}, GaN:Zn, Gd₃Ga₅O₁₂:Cr³⁺, Gd₃Ga₅O₁₂:Cr,Ce, GdNbO₄:Bi³⁺, Gd₂O₂S:Eu³⁺, Gd₂O₂Pr³⁺, Gd₂O₂S:Pr,Ce, F, Gd₂O₂S:Tb³⁺, Gd₂SiO₅:Ce³⁺, KAl₁₁O₁₇:Tl⁺, KGa₁₁O₁₇:Mn²⁺, K₂La₂Ti₃O₁₀:Eu, KMgF₃:Eu²⁺, KMgF₃:Mn²⁺, K₂SiF₆:Mn⁴⁺, LaAl₃B₄O₁₂:Eu³⁺, LaAlB₂O₆:Eu³⁺, LaAlO₃:Eu³⁺, LaAlO₃:Sm³⁺, LaAsO₄:Eu³⁺, LaBr₃:Ce³⁺, LaBO₃:Eu³⁺, (La,Ge,Tb) PO₄:Ce:Tb, LaCl₃:Ce³⁺, La₂O₃:Bi³⁺, LaOBr:Tb³⁺, LaOBr:Tm³⁺, LaOCl:Bi³⁺, LaOCl:Eu³⁺, LaOF:Eu³⁺, La₂O₃:Eu³⁺, La₂O₃:Pr³⁺, La₂O₂S:Tb³⁺, LaPO₄:Ce³⁺, LaPO₄:Eu³⁺, LaSiO₃Cl:Ce³⁺, LaSiO₃Cl:Ce³⁺,Tb³⁺, LaVO₄:EU³⁺, La₂W₃O₁₂:Eu³⁺, LiAlF₄:Mn²⁺, LiAl₅O₈:Fe³⁺, LiAlO₂:Fe³⁺, LiAlO₂:Mn²⁺, LiAl₅O₈:Mn²⁺, Li₂CaP₂O₇:Ce³⁺,Mn²⁺, LiCeBa₄Si₄O₁₄:Mn²⁺, LiCeSrBa₃Si₄O₁₄:Mn²⁺, LiInO₂:Eu³⁺, LiInO₂:Sm³⁺, LiLaO₂:Eu³⁺, LuAlO₃:Ce³⁺, (Lu,Gd)₂Si0₅:Ce³⁺, Lu₂SiO₅:Ce³⁺, Lu₂Si₂O₇:Ce³⁺, LuTaO₄:Nb⁵⁺, Lu_{1-X}YₓAlO₃:Ce³⁺, MgAl₂O₄:Mn²⁺, MgSrAl₁₀O₁₇:Ce, MgB₂O₄:Mn²⁺, MgBa₂(PO₄)₂:Sn²⁺, MgBa₂(PO₄)₂:U, MgBaP₂O₇:Eu²⁺, MgBaP₂O₇:Eu²⁺, Mn²⁺, MgBa₃Si₂O₈:Eu²⁺, MgBa(SO₄)₂:Eu²⁺, Mg₃Ca₃(PO₄)₄:Eu²⁺, MgCaP₂O₇:Mn²⁺, Mg₂Ca(SO₄)₃:Eu²⁺, Mg₂Ca(SO₄)₃:Eu²⁺,Mn², MgCeAlₙO₁₉:Tb³⁺, Mg₄(F)GeO₆:Mn²⁺, Mg₄(F)(Ge,Sn)O₆:Mn²⁺, MgF₂:Mn²⁺, MgGa₂O₄:Mn²⁺, Mg₈Ge₂O₁₁F₂:Mn⁴⁺, MgS:Eu²⁺, MgSiO₃:Mn²⁺, Mg₂SiO₄:Mn²⁺, Mg₃SiO₃F₄:Ti⁴⁺, MgSO₄:Eu²⁺, MgSO₄:Pb²⁺, MgSrBa₂Si₂O₇:Eu²⁺, MgSrP₂O₇:Eu²⁺, MgSr₅(PO₄)₄:Sn²⁺, MgSr₃Si₂O₈:Eu²⁺, Mn²⁺, Mg₂Sr(SO₄)₃:Eu²⁺, Mg₂TiO₄:Mn⁴⁺, MgWO₄, MgYBO₄:Eu³⁺, Na₃Ce(PO₄)₂:Tb³⁺, NaI:Tl, Na_{1.23}K_{O.42}Eu_{0.12}TiSi₄O₁₁:EU³⁺, Na_{1.23}K_{0.42}Eu_{0.12}TiSi₅O₁₃.xH₂O:EU³⁺, Na_{1.29}K_{0.46}Er_{0.08}TiSi₄O₁₁:Eu³⁺, Na₂Mg₃Al₂Si₂O₁₀:Tb, Na(Mg₂₋ₓMnₓ)LiSi₄O₁₀F₂:Mn, NaYF₄:Er³⁺, Yb³⁺, NaYO₂:Eu³⁺, P46(70%)+P47 (30%), SrAl₁₂O₁₉:Ce³⁺, Mn²⁺, SrAl₂O₄:Eu²⁺, SrAl₄O₇:Eu³⁺, SrAl₁₂O₁₉:Eu²⁺, SrAl₂S₄:Eu²⁺, Sr₂B₅O₉Cl:Eu²⁺, SrB₄O₇:Eu²⁺(F,Cl,Br), SrB₄O₇:Pb²⁺, SrB₄O₇:Pb²⁺, Mn²⁺, SrB₈O₁₃:Sm²⁺, SrₓBa_{y}Cl_{z}Al₂O_{4-z/2}: Mn²⁺, Ce³⁺, SrBaSiO₄:Eu²⁺, Sr(Cl,Br,I)₂:Eu²⁺ in SiO₂, SrCl₂:Eu²⁺ in SiO₂, Sr₅Cl(PO₄)₃:Eu, Sr_{w}FₓB₄O_{6.5}:Eu²⁺, Sr_{w}FₓB_{y}O_{z}:Eu²⁺,Sm²⁺SrF₂:Eu²⁺, SrGa₁₂O₁₉:Mn²⁺, SrGa₂S₄:Ce³⁺, SrGa₂S₄:Eu²⁺, SrGa₂S₄:Pb²⁺, SrIn₂O₄:Pr³⁺, Al³⁺, (Sr,Mg)₃(PO₄)₂:Sn, SrMgSi₂O₆:Eu²⁺, Sr₂MgSi₂O₇:Eu²⁺, Sr₃MgSi₂O₈:Eu²⁺, SrMoO₄:U, SrO.3B₂O₃:Eu²⁺,Cl, β-SrO.3B₂O₃:Pb²⁺, β-SrO.3B₂O₃:Pb²⁺, Mn²⁺, α-SrO.3B₂O₃:Sm²⁺, Sr₆P₅BO₂₀:Eu, Sr₅(PO₄)₃Cl:EU²⁺, Sr₅(PO₄)₃Cl:EU²⁺,Pr³⁺, Sr₅(PO₄)₃Cl:Mn²⁺, Sr₅(PO₄)₃Cl:Sb³⁺, Sr₂P₂O₇:Eu²⁺, β-Sr₃(PO₄)₂:Eu²⁺, Sr₅(PO₄)₃F:Mn²⁺, Sr₅(PO₄)₃F:Sb³⁺, Sr₅(PO₄)₃F:Sb³⁺,Mn²⁺, Sr₅(PO₄)₃F:Sn²⁺, Sr₂P₂O₇:Sn²⁺, β-Sr₃(PO₄)₂:Sn²⁺, β-Sr₃(PO₄)₂:Sn²⁺,Mn²⁺(Al), SrS:Ce³⁺, SrS:Eu²⁺, SrS:Mn²⁺, SrS:Cu⁺,Na, SrSO₄:Bi, SrSO₄:Ce³⁺, SrSO₄:Eu²⁺, SrSO₄:Eu²⁺, Mn²⁺, Sr₅Si₄O₁₀Cl₆:Eu²⁺, Sr₂SiO₄:Eu²⁺, SrTiO₃:Pr³⁺, SrTiO₃:Pr³, Al³⁺, Sr₃WO₆:U, SrY₂O₃:Eu³⁺, ThO₂:Eu³⁺, ThO₂:Pr³⁺, ThO₂:Tb³⁺, YAl₃B₄O₁₂:Bi³⁺, YAl₃B₄O₁₂:Ce³⁺, YAl₃B₄O₁₂:Ce³⁺,Mn, YAl₃B₄O₁₂:Ce³,Tb³⁺, YAl₃B₄O₁₂:EU³⁺, YAl₃B₄O₁₂:EU³⁺,Cr³⁺, YAl₃B₄O₁₂:Th⁴⁺,Ce³⁺,Mn²⁺, YAlO₃:Ce³⁺, Y₃Al₅O₁₂:Ce³⁺, Y₃Al₅O₁₂:Cr³⁺, YAlO₃:Eu³⁺, Y₃Al₅O₁₂:Eu^{3r}, Y₄Al₂O₉:Eu³⁺, Y₃Al₅O₁₂:Mn⁴⁺, YAlO₃:Sm³⁺, YAlO₃:Tb³⁺, Y₃Al₅O₁₂:Tb³⁺, YAsO₄:Eu³⁺, YBO₃:Ce³⁺, YBO₃:Eu³⁺, YF₃:Er³⁺,Yb³⁺, YF₃:Mn²⁺, YF₃:Mn²⁺,Th⁴⁺, YF₃:Tm³⁺,Yb³⁺, (Y,Gd)BO₃:Eu, (Y,Gd)BO₃:Tb, (Y,Gd)₂O₃:Eu³⁺, Y_{1.34}Gd_{0.60}O₃(Eu, Pr), Y₂O₃:Bi³⁺, YOBr:Eu³⁺, Y₂O₃:Ce, Y₂O₃:Er³⁺, Y₂O₃:Eu³⁺ (YOE), Y₂O₃:Ce³⁺,Tb³⁺, YOCl:Ce³⁺, YOCl:Eu³⁺, YOF:Eu³⁺, YOF:Tb³⁺, Y₂O₃:Ho³⁺, Y₂O₂S:Eu³⁺, Y₂O₂S:Pr³⁺, Y₂O₂S:Tb³⁺, Y₂O₃:Tb³⁺, YPO₄:Ce³⁺, YPO₄:Ce³⁺,Tb³⁺, YPO₄:Eu³⁺, YPO₄:Mn²⁺,Th⁴⁺, YPO₄:V⁵⁺, Y(P,V)O₄:Eu, Y₂SiO₅:Ce³⁺, YTaO₄, YTaO₄:Nb⁵⁺, YVO₄:Dy³⁺, YVO₄:Eu³⁺, ZnAl₂O₄:Mn²⁺, ZnB₂O₄:Mn²⁺, ZnBa₂S₃:Mn²⁺, (Zn,Be)₂SiO₄:Mn²⁺, Zn_{0.4}Cd_{0.6}S:Ag, Zn_{0.6}Cd_{0.4}S:Ag, (Zn,Cd)S:Ag,Cl, (Zn,Cd)S:Cu, ZnF₂:Mn²⁺, ZnGa₂O₄, ZnGa₂O₄:Mn²⁺, ZnGa₂S₄:Mn²⁺, Zn₂GeO₄:Mn²⁺, (Zn,Mg)F₂:Mn²⁺, ZnMg₂(PO₄)₂:Mn²⁺, (Zn,Mg)₃(PO₄)₂:Mn²⁺, ZnO:Al³⁺,Ga³⁺, ZnO:Bi³⁺, ZnO:Ga³⁺, ZnO:Ga, ZnO—CdO:Ga, ZnO:S, ZnO:Se, ZnO:Zn, ZnS:Ag⁺,Cl⁻, ZnS:Ag,Cu,Cl, ZnS:Ag,Ni, ZnS:Au,In, ZnS—CdS (25-75), ZnS—CdS (50-50), ZnS—CdS (75-25), ZnS—CdS:Ag,Br,Ni, ZnS—CdS:Ag⁺,Cl, ZnS—CdS:Cu,Br, ZnS—CdS:Cu,I, ZnS:Cl⁻, ZnS:Eu²⁺, ZnS:Cu, ZnS:Cu⁺,A³⁺, ZnS:Cu⁺,Cl⁻, ZnS:Cu,Sn, ZnS:Eu²⁺, ZnS:Mn²⁺, ZnS:Mn,Cu, ZnS:Mn²⁺,Te²⁺, ZnS:P, ZnS:P³⁻,Cl⁻, ZnS:Pb²⁺, ZnS:Pb²⁺,Cl⁻, ZnS:Pb,Cu, Zn₃(PO₄)₂:Mn²⁺, Zn₂SiO₄:Mn²⁺, Zn₂SiO₄:Mn²⁺,As⁵⁺, Zn₂SiO₄:Mn,Sb₂O₂, Zn₂SiO₄:Mn²⁺,P, Zn₂SiO₄:Ti⁴⁺, ZnS:Sn²⁺, ZnS:Sn,Ag, ZnS:Sn²⁺,Li⁺, ZnS:Te,Mn, ZnS—ZnTe:Mn²⁺, ZnSe:Cu⁺,Cl, ZnWO₄

Furthermore, the compound according to the invention exhibits, in particular, advantages in the mixture with further phosphors of a different fluorescence colour or on use in LEDs together with such phosphors.

It has been found here that, in particular on combination of the compounds according to the invention with red-emitting phosphors, the optimisation of lighting parameters for white LEDs is achieved particularly well.

Correspondingly, it is preferred in an embodiment according to the invention for the light source to comprise a red-emitting phosphor in addition to the phosphor according to the invention.

Corresponding phosphors are known to the person skilled in the art or can be selected by the person skilled in the art from the list given above. Suitable red-emitting phosphors here are frequently nitrides, sialones or sulfides. Examples are: 2-5-8 nitrides, such as (Ca,Sr,Ba)₂Si₅N₈:Eu, (Ca,Sr)₂Si₅N₈:Eu, (Ca,Sr)AlSiN₃:Eu, (Ca,Sr)S:Eu, (Ca,Sr)(S,Se):Eu, (Sr,Ba,Ca)Ga₂S₄:Eu, and also oxynitridic compounds.

An advantage of the mixtures of oxynitrides compared with mixtures of different classes of substance are more homogeneous properties; the chemical stability, the morphology, the temperature behaviour, etc., of the phosphors are virtually identical. This facilitates stable light properties of the phosphor-converted LED and a homogeneous mixture of the phosphor components, reducing the binning expense in LED construction.

Suitable oxynitrides are, in particular, the europium-doped silicooxynitrides. Corresponding preferred silicooxynitrides to be employed substantially correspond in their composition to the compounds according to the invention, where the dopant used is europium instead of cerium.

In a variant, the red-emitting oxynitrides are those of the formula

A_{2-0.5y-x+1.5z}EuₓSi₅N_{8-y+z}O_{y}

where A stands for one or more elements selected from Ca, Sr, Ba, and x stands for a value from the range from 0.005 to 1 and y stands for a value from the range from 0.01 to 3 and z stands for a value from the range from 0 to 3. The preparation and use of corresponding compounds are described in WO 2011/091839. Particular preference is given here to the use of phosphors of the formula [Ca, Sr]_{2-0.5y-x+1.5z}EuₓSi₅N_{8-y+z}O_{y}.

In a further preferred embodiment of the invention, red-emitting compounds of the formula

A_{2-c+1.5z}Eu_{c}Si₅N_{8-2/3x+z}Oₓ

are employed, where the indices used have the following meanings: A stands for one or more elements selected from Ca, Sr, Ba; 0.01≦c≦0.2; 0<x≦1; 0≦z≦3.0 and a+b+c≦2+1.5z. Particular preference is given here to the use of phosphors of the formula [Ca, Sr]_{2-c+1.5z}Eu_{c}Si₅N_{8-2/3x+z}Oₓ. Corresponding compounds and preparation processes are described in the earlier patent application with the application file reference EP12005188.3. According to this, the compounds can be obtained by a process in which a mixture of a europium-doped alkaline-earth metal siliconitride or europium-doped alkaline-earth metal silicooxynitride and an alkaline-earth metal nitride is prepared, where the alkaline-earth metal of the europium-doped alkaline-earth metal siliconitride or silicooxynitride and of the alkaline-earth metal nitride may be identical or different, and the mixture is calcined under non-oxidising conditions. The europium-doped alkaline-earth metal siliconitride or silicooxynitride employed in the above-mentioned process is preferably a compound of the following general formula EA_{d}Eu_{c}EₑN_{f}Oₓ, in which the following applies to the symbols and indices used: EA is at least one alkaline-earth metal, in particular selected from the group consisting of Ca, Sr and Ba; E is at least one element from the fourth main group, in particular Si; 0.80≦d≦1.995; 0.005≦c≦0.2; 4.0≦e≦6.00; 5.00≦f≦8.70; 0≦x≦3.00; where the following relationship furthermore applies to the indices: 2d+2c+4e=3f+2x. The europium-doped alkaline-earth metal siliconitride or silicooxynitride used in step (a) can be prepared by any process known from the prior art, as described, for example, in WO 2011/091839. However, it is particularly preferred for the europium-doped alkaline-earth metal siliconitride or silicooxynitride to be prepared by a step (a′) of calcination of a mixture comprising a europium source, a silicon source and an alkaline-earth metal nitride under non-oxidising conditions. This step (a′) precedes step (a) of the above-mentioned process. The europium source employed can be any conceivable europium compound with which a europium-doped alkaline-earth metal siliconitride or silicooxynitride can be prepared. The europium source employed in the process according to the invention is preferably europium oxide (in particular Eu₂O₃) and/or europium nitride (EuN), in particular Eu₂O₃. The silicon source employed can be any conceivable silicon compound with which a europium-doped alkaline-earth metal siliconitride or silicooxynitride can be prepared. The silicon source employed in the process according to the invention is preferably silicon nitride and optionally silicon oxide. If a pure nitride is to be prepared, the silicon source is preferably silicon nitride. If the preparation of an oxynitride is desired, the silicon source employed is also silicon dioxide besides silicon nitride. An alkaline-earth metal nitride is taken to mean a compound of the formula M₃N₂, in which M is on each occurrence, independently of one another, an alkaline-earth metal ion, in particular selected from the group consisting of calcium, strontium and barium. In other words, the alkaline-earth metal nitride is preferably selected from the group consisting of calcium nitride (Ca₃N₂), strontium nitride (Sr₃N₂), barium nitride (Ba₃N₂) and mixtures thereof. The compounds employed in step (a′) for the preparation of the europium-doped alkaline-earth metal siliconitride or silicooxynitride are preferably employed in a ratio to one another such that the number of atoms of the alkaline-earth metal, of silicon, of europium, of nitrogen and, where present, of oxygen corresponds to the desired ratio in the alkaline-earth metal siliconitride or silicooxynitride of the above-mentioned formula (I), (Ia), (Ib) or (II). In particular, a stoichiometric ratio is used, but a slight excess of the alkaline-earth metal nitride is also possible. The weight ratio of the europium-doped alkaline-earth metal siliconitride or silicooxynitride to the alkaline-earth metal nitride in step (a) of the process according to the invention is preferably in the range from 2:1 to 20:1 and more preferably in the range from 4:1 to 9:1. The process here is carried out under non-oxidising conditions, i.e. under substantially or completely oxygen-free conditions, in particular under reducing conditions.

In a variant of the invention, it is in turn preferred for the phosphors to be arranged on the primary light source in such a way that the red-emitting phosphor is essentially hit by light from the primary light source, while the green-emitting phosphor is essentially hit by light which has already passed through the red-emitting phosphor or has been scattered thereby. This can be achieved by installing the red-emitting phosphor between the primary light source and the green-emitting phosphor.

The phosphors or phosphor combinations according to the invention can either be dispersed in a resin (for example epoxy or silicone resin) or, in the case of suitable size ratios, arranged directly on the primary light source or alternatively arranged remote therefrom, depending on the application (the latter arrangement also includes “remote phosphor technology”). The advantages of remote phosphor technology are known to the person skilled in the art and are revealed, for example, by the following publication: Japanese Journ. of Appl. Phys. Vol. 44, No. 21 (2005). L649-L651.

In a further embodiment, it is preferred for the optical coupling between the phosphor and the primary light source to be achieved by a light-conducting arrangement. This makes it possible for the primary light source to be installed at a central location and to be optically coupled to the phosphor by means of light-conducting devices, such as, for example, optical fibres. In this way, it is possible to achieve lamps adapted to the lighting wishes which merely consist of one or various phosphors, which can be arranged to form a light screen, and an optical waveguide, which is coupled to the primary light source. In this way, it is possible to place a strong primary light source at a location which is favourable for electrical installation and to install lamps comprising phosphors which are coupled to the optical waveguides at any desired locations without further electrical cabling, but instead only by laying optical waveguides.

The invention furthermore relates to a lighting unit, in particular for the backlighting of display devices, characterised in that it comprises at least one light source according to the invention, and to a display device, in particular liquid-crystal display device (LC display), with backlighting, characterised in that it comprises at least one lighting unit according to the invention.

The particle size of the phosphors according to the invention on use in LEDs is usually between 50 nm and 30 μm, preferably between 1 μm and 20 m. For use in LEDs, the phosphors can also be converted into any desired outer shapes, such as spherical particles, platelets and structured materials and ceramics. These shapes are in accordance with the invention summarised under the term “shaped bodies”. The shaped body is preferably a “phosphor body”. The present invention thus furthermore relates to a shaped body comprising the phosphors according to the invention. The production and use of corresponding shaped bodies are familiar to the person skilled in the art from numerous publications.

All variants of the invention described here can be combined with one another so long as the respective embodiments are not mutually exclusive. In particular, it is an obvious operation, on the basis of the teaching of this specification, as part of routine optimisation, precisely to combine various variants described here in order to obtain a specific particularly preferred embodiment. The following examples are intended to illustrate the present invention and show, in particular, the result of such illustrative combinations of the invention variants described. However, they should in no way be regarded as limiting, but instead are intended to stimulate generalisation. All compounds or components which can be used in the preparations are either known and commercially available or can be synthesised by known methods. The temperatures indicated in the examples are always in ° C. It furthermore goes without saying that, both in the description and also in the examples, the amounts of the components added in the compositions always add up to a total of 100%. Percent data should always be regarded in the given connection.

### EXAMPLES

### Example 1

### Preparation of Various Compositions of Compounds of the Formula I According to the Invention

### Example 1a

### Synthesis of Sr_{1.92}Ce_{0.04}Li_{0.04}Si₅N_{7.67}O_{0.5}

In a glove box, 0.67 mmol of lithium nitride Li₃N, 2.00 mmol of cerium nitride CeN, 79.17 mmol of silicon nitride Si₃N₄ and 32.00 mmol of strontium nitride Sr₃N₂ and 12.50 mmol of silicon dioxide SiO₂ are mixed and subsequently homogenised by mortaring in an agate mortar. The mixture obtained in this way is transferred into a boron nitride calcination dish and transferred into a high-temperature oven under inert conditions. The calcination of the material is carried out at 1600° C. for 8 h with supply of an N₂/H₂ gas mixture. The calcined sample is subsequently mortared, sieved using a nylon sieve<36 μm and characterised by crystallography and spectroscopy.

The powder diagram of the product is shown in FIG. 1. The resultant product exhibits the fluorescence spectrum in accordance with FIG. 2 and the excitation spectrum in accordance with FIG. 3.

### Example 1b

The following compounds are prepared analogously:

| Product | Starting materials |
|---|---|
| Sr_{0.99}Ba_{0.93}Ce_{0.04}Li_{0.04}Si₅N_{7.67}O_{0.5} | Ba₃N₂, Sr₃N₂, CeN, Si₃N₄, SiO₂, Li₃N |
| Sr_{0.99}Ba_{0.93}Ce_{0.04}Na_{0.04}Si₅N_{7.67}O_{0.5} | Ba₃N₂, Sr₃N₂, CeN, Si₃N₄, SiO₂, NaNO₃ |
| Sr_{0.99}Ba_{0.93}Ce_{0.04}K_{0.04}Si₅N_{7.67}O_{0.5} | Ba₃N₂, Sr₃N₂, CeN, Si₃N₄, SiO₂, KNO₃ |
| Sr_{1.76}Ca_{0.2}Ce_{0.02}Li_{0.02}Si₅N_{7.67}O_{0.5} | Ca₃N₂, Sr₃N₂, CeN, Si₃N₄, SiO₂, Li₃N |
| Sr_{0.65}Ba_{0.9}Ca_{0.37}Ce_{0.04}Li_{0.04}Si₅N_{7.67}O_{0.5} | Sr₃N₂, Ba₃N₂, Ca₃N₂, CeN, Si₃N₄, SiO₂, |
| | Li₃N |
| Sr_{0.99}Ba_{0.91}Ce_{0.1}Si₅N_{7.7}O_{0.5} | Ba₃N₂, Sr₃N₂, CeN, Si₃N₄, SiO₂ |
| Sr_{1.25}Ca_{0.4}Ce_{0.1}Si₅N_{7.6}O_{0.4} | Ca₃N₂, Sr₃N₂, CeN, Si₃N₄, SiO₂ |
| Sr_{0.95}Ba_{0.7}Ce_{0.1}Si₅N_{7.6}O_{0.4} | Ba₃N₂, Sr₃N₂, CeN, Si₃N₄, SiO₂ |
| Sr_{0.97}Ba_{0.7}Ce_{0.04}Na_{0.04}Si₅N_{7.78}O_{0.22} | Ba₃N₂, Sr₃N₂, CeN, Si₃N₄, SiO₂, NaNO₃ |
| Sr_{0.99}Ba_{0.93}Ce_{0.04}Li_{0.04}Si_{3.8}Ge_{1.2}N_{7.67}O_{0.5} | Ba₃N₂, Sr₃N₂, CeN, Si₃N₄, Ge₃N₄, SiO₂, |
| | Li₃N |
| Sr_{0.99}Ba_{0.93}Ce_{0.04}Li_{0.04}Si_{4.8}N_{7.67}O_{0.5}C_{0.2} | Ba₃N₂, Sr₃N₂, CeN, Si₃N₄, SiO₂, Li₃N, C |
| Sr_{0.99}Ba_{0.93}Ce_{0.05}Li_{0.05}Al_{0.5}Si_{4.5}N_{7.0}O_{1.0} | Ba₃N₂, Sr₃N₂, AlN, CeN, Si₃N₄, SiO₂, |
| | Li₃N |
| Sr_{0.99}Ba_{0.93}Ce_{0.05}Li_{0.05}B_{0.2}Si_{4.8}N_{7.3}O_{0.7} | Ba₃N₂, Sr₃N₂, AlN, CeN, Si₃N₄, SiO₂, |
| | Li₃N, B₂O₃ |
| Sr_{0.3}Ba_{0.25}Ce_{0.05}Li_{0.05}Si₅N_{5.3}O_{2.7} | Ba₃N₂, Sr₃N₂, CeN, Si₃N₄, SiO₂, Li₃N |
| Sr_{0.98}Ba_{0.93}Ce_{0.04}Eu_{0.01}Li_{0.04}Si₅N_{7.67}O_{0.5} | Ba₃N₂, Sr₃N₂, CeN, Si₃N₄, SiO₂, Li₃N, |
| | Eu₂O₃ |
| Sr_{1.765}Ce_{0.04}Eu_{0.005}Li_{0.04}Si₅N_{7.7}O_{0.3} | Sr₃N₂, CeN, Si₃N₄, SiO₂, Li₃N, Eu₂O₃ |

The corresponding fluorescence spectra show emission bands in the green wavelength region. The following emission maxima (peak wavelengths) and the emission spectrum in FIG. 4 may be mentioned by way of example:

Sr_{0.99}Ba_{0.93}Ce_{0.04}Li_{0.04}Si₅N_{7.67}O_{0.5}: peak wavelength 513 nm
Sr_{0.65}Ba_{0.9}Ca_{0.37}Ce_{0.04}Li_{0.04}Si₅N_{7.67}O_{0.5}: peak wavelength 532 nm
Sr_{1.25}Ca_{0.4}Ce_{0.1}Si₅N_{7.6}O_{0.4}: peak wavelength 549 nm

### Example 1c

### (Sr,Ba)_{1.70} Ce_{0.10}Li_{0.10}Si₅N_{7.8}O_{0.2}

0.434 g of CeO₂ (2.52 mmol), 0.029 g of Li₃N (0.84 mmol), 3.500 g of Ba₃N₂ (7.95 mmol), 5.552 g of Si₃N₄(39.58 mmol), 0.376 g of SiO₂ (6.25 mmol) and 2.313 g of Sr₃N₂(7.95 mmol) are weighed out together in a glove box and mixed in the hand mortar until a homogeneous mixture has formed.

The mixture is transferred into a boron nitride boat and placed in the centre of a tubular furnace on a molybdenum foil tray and calcined at 1625° C. for 6 hours under a nitrogen/hydrogen atmosphere (60 l/min of N₂+25 l/min of H₂).

### Example 1d

### (Sr,Ba)_{1.70} Ce_{0.10}Li_{0.10}Si₅N_{7.8}O_{0.2}

1.721 g of CeO₂ (10 mmol), 0.116 g of Li₃N (3.333 mmol), 28.008 g of Ba₃N₂ (63.336 mmol), 22.660 g of Si₃N₄(158.300 mmol) and 1.502 g of SiO₂ (25.000 mmol) are weighed out together in a glove box and mixed in the hand mortar until a homogeneous mixture has formed.

The mixture is transferred into a boron nitride boat and placed in the centre of a tubular furnace on a molybdenum foil tray and calcined at 1625° C. for 8 hours under a nitrogen/hydrogen atmosphere (60 l/min of N₂+20 l/min of H₂).

20 percent by weight of strontium nitride are added to the resultant phosphor in a glove box and mixed until a homogeneous mixture has formed. A further calcination is subsequently carried out, with the conditions identical to the first calcination step. In order to remove excess nitride, the resultant phosphor is suspended in 1 molar hydrochloric acid for a further one hour, subsequently filtered off and dried.

### Example 1e

### (Sr,Ba)_{1.82} Ce_{0.02}Li_{0.02} Eu_{0.04}Si₅N_{7.8}O_{0.2}

0.086 g of CeO₂ (0.50 mmol), 0.006 g of Li₃N (0.17 mmol), 0.352 g of Eu₂O₃ (1 mmol), 3.500 g of Ba₃N₂(7.95 mmol), 6.077 g of Si₃N₄(43.33 mmol), 0.376 g of SiO₂ (6.25 mmol) and 2.313 g of Sr₃N₂(7.95 mmol) are weighed out together in a glove box and mixed in the hand mortar until a homogeneous mixture has formed. The mixture is transferred into a boron nitride boat and placed in the centre of a tubular furnace on a molybdenum foil tray and calcined at 1625° C. for 6 hours under a nitrogen/hydrogen atmosphere (50 l/min of N₂+20 l/min of H₂).

### Example 1f

### (Sr,Ba)_{1.82} Ce_{0.02}Li_{0.02} Eu_{0.04}Si₅N_{7.8}O_{0.2}

0.086 g of CeO₂ (0.50 mmol), 0.006 g of Li₃N (0.17 mmol), 0.352 g of Eu₂O₃ (1 mmol), 3.500 g of Ba₃N₂(7.95 mmol), 5.552 g of Si₃N₄(39.58 mmol), 0.376 g of SiO₂ (6.25 mmol) and 2.313 g of Sr₃N₂(7.95 mmol) are weighed out together in a glove box and mixed in the hand mortar until a homogeneous mixture has formed. The mixture is transferred into a boron nitride boat and placed in the centre of a tubular furnace on a molybdenum foil tray and calcined at 1625° C. for 6 hours under a nitrogen/hydrogen atmosphere (50 l/min of N₂+20 l/min of H₂).

### Example 1g

### (Sr,Ba)_{1.82} Ce_{0.02}Li_{0.02} Eu_{0.04}Si₅N_{7.8}O_{0.2}

0.341 g of CeO₂ (1.98 mmol), 0.023 g of Li₃N (0.66 mmol), 0.700 g of Eu₂O₃ (1.98 mmol), 28.008 g of Ba₃N₂(63.34 mmol), 22.660 g of Si₃N₄ (158.300 mmol) and 1.502 g of SiO₂ (25.000 mmol) are weighed out together in a glove box and mixed in the hand mortar until a homogeneous mixture has formed. The mixture is transferred into a boron nitride boat and placed in the centre of a tubular furnace on a molybdenum foil tray and calcined at 1625° C. for 6 hours under a nitrogen/hydrogen atmosphere (60 l/min of N₂+25 l/min of H₂).

20 percent by weight of strontium nitride are added to the resultant phosphor in a glove box and mixed until a homogeneous mixture has formed. A further calcination is subsequently carried out, with the conditions identical to the first calcination step. In order to remove excess nitride, the resultant phosphor is suspended in 1 molar hydrochloric acid for a further one hour, subsequently filtered off and dried.

### Example 1h

### Synthesis of (Sr,Ba)_{1.82} Ce_{0.02}Na_{0.02} Eu_{0.04}Si₅N_{7.8}O_{0.2}

0.086 g of CeO₂ (0.50 mmol), 0.006 g of Na₂O (0.25 mmol), 0.352 g of Eu₂O₃ (1 mmol), 3.500 g of Ba₃N₂(7.95 mmol), 5.552 g of Si₃N₄(39.58 mmol), 0.376 g of SiO₂ (6.25 mmol) and 2.313 g of Sr₃N₂(7.95 mmol) are weighed out together in a glove box and mixed in the hand mortar until a homogeneous mixture has formed. The mixture is transferred into a boron nitride boat and placed in the centre of a tubular furnace on a molybdenum foil tray and calcined at 1625° C. for 6 hours under a nitrogen/hydrogen atmosphere (60 l/min of N₂+25 l/min of H₂).

### Example 1j

### (Sr,Ba)_{1.82} Ce_{0.02}Na_{0.02} Eu_{0.04}Si₅N_{7.8}O_{0.2}

0.086 g of CeO₂ (0.50 mmol), 0.006 g of Na₂O (0.25 mmol), 0.352 g of Eu₂O₃ (1 mmol), 3.500 g of Ba₃N₂(7.95 mmol), 5.552 g of Si₃N₄(39.58 mmol), 0.376 g of SiO₂ (6.25 mmol) and 2.313 g of Sr₃N₂(7.95 mmol) are weighed out together in a glove box and mixed in the hand mortar until a homogeneous mixture has formed. The mixture is transferred into a boron nitride boat and placed in the centre of a tubular furnace on a molybdenum foil tray and calcined at 1625° C. for 6 hours under a nitrogen/hydrogen atmosphere (60 l/min of N₂+25 l/min of H₂).

20 percent by weight of a proportionate mixture of 40% of Sr₃N₂ and 60% of Ba₃N₂ are added to 80 g of the resultant phosphor in a glove box and mixed until a homogeneous mixture has formed. A further calcination is subsequently carried out, with the conditions identical to the first calcination step. The resultant phosphor is suspended in 1 molar hydrochloric acid for a further one hour, subsequently filtered off and dried.

### Example 1k

### (Sr,Ba)_{1.82} Ce_{0.02}K_{0.02} Eu_{0.04}Si₅N_{7.8}O_{0.2}

0.086 g of CeO₂ (0.50 mmol), 0.035 g of K₂CO₃ (0.25 mmol-dried), 0.352 g of Eu₂O₃(1 mmol), 3.500 g of Ba₃N₂(7.95 mmol), 5.552 g of Si₃N₄(39.58 mmol), 0.376 g of SiO₂ (6.25 mmol) and 2.313 g of Sr₃N₂(7.95 mmol) are weighed out together in a glove box and mixed in the hand mortar until a homogeneous mixture has formed. The mixture is transferred into a boron nitride boat and placed in the centre of a tubular furnace on a molybdenum foil tray and calcined at 1625° C. for 6 hours under a nitrogen/hydrogen atmosphere (60 l/min of N₂+25 l/min of H₂).

20 percent by weight of a proportionate mixture of 40% of Sr₃N₂ and 60% of Ba₃N₂ are added to 80 g of the resultant phosphor in a glove box and mixed until a homogenous mixture has formed. A further calcination is subsequently carried out, with the conditions identical to the first calcination step. In order to remove excess nitride, the resultant phosphor is suspended in 1 molar hydrochloric acid for a further one hour, subsequently filtered off and dried.

### Example 2

### Coating of the Phosphors

### Example 2a

### Coating of the Phosphors According to the Invention with SiO₂

50 g of one of the phosphors according to the invention described above are suspended in 1 litre of ethanol in a 2 l reactor with ground-glass lid, heating mantle and reflux condenser. A solution of 17 g of ammonia water (25% by weight of NH₃) in 70 ml of water and 100 ml of ethanol is added. A solution of 48 g of tetraethyl orthosilicate (TEOS) in 48 g of anhydrous ethanol is slowly added dropwise (about 1.5 ml/min) at 65° C. with stirring. When the addition is complete, the suspension is stirred for a further 1.5 h, brought to room temperature and filtered. The residue is washed with ethanol and dried at 150° C. to 200° C.

### Example 2b

### Coating of the Phosphors According to the Invention with

Al₂O₃

50 g of one of the phosphors according to the invention described above are suspended in 950 g of ethanol in a glass reactor with heating mantle. 600 g of an ethanolic solution of 98.7 g of AlCl₃*6H₂O per kg of solution are metered into the suspension over 3 h at 80° C. with stirring. During this addition, the pH is kept constant at 6.5 by metered addition of sodium hydroxide solution. When the metered addition is complete, the mixture is stirred at 80° C. for a further 1 h, then cooled to room temperature, the phosphor is filtered off, washed with ethanol and dried.

### Example 2c

### Coating of the Phosphors According to the Invention with B₂O₃

50 g of one of the phosphors according to the invention described above are suspended in 1000 ml of water in a glass reactor with heating mantle. The suspension is heated to 60° C., and 4.994 g of boric acid H₃BO₃ (80 mmol) are added with stirring. The suspension is cooled to room temperature with stirring and subsequently stirred for 1 h. The suspension is then filtered off with suction and dried in a drying cabinet. After drying, the material is calcined at 500° C. under a nitrogen atmosphere.

### Example 2d

### Coating of the Phosphors According to the Invention with BN

50 g of one of the phosphors according to the invention described above are suspended in 1000 ml of water in a glass reactor with heating mantle. The suspension is heated to 60° C., and 4.994 g of boric acid H₃BO₃ (80 mmol) are added with stirring. The suspension is cooled to room temperature with stirring and subsequently stirred for 1 h. The suspension is then filtered off with suction and dried in a drying cabinet. After drying, the material is calcined at 1000° C. under a nitrogen/ammonia atmosphere.

### Example 2e

### Coating of the Phosphors According to the Invention with ZrO₂

50 g of one of the phosphors according to the invention described above are suspended in 1000 ml of water in a glass reactor with heating mantle. The suspension is heated to 60° C. and adjusted to pH 3.0. 10 g of a 30 percent by weight ZrOCl₂ solution are subsequently metered in slowly with stirring. When the metered addition is complete, the mixture is stirred for a further 1 h, subsequently filtered off with suction and washed with DI water. After drying, the material is calcined at 600° C. under a nitrogen atmosphere.

### Example 2f

### Coating of the Phosphors According to the Invention with MgO

50 g of one of the phosphors according to the invention described above are suspended in 1000 ml of water in a glass reactor with heating mantle. The suspension is held at a temperature of 25° C., and 19.750 g of ammonium hydrogencarbonate (250 mmol) are added. 100 ml of a 15 percent by weight magnesium chloride solution are added slowly. When the metered addition is complete, the mixture is stirred for a further 1 h, subsequently filtered off with suction and washed with DI water. After drying, the material is calcined at 1000° C. under a nitrogen/hydrogen atmosphere.

### Example 3

### LED Application of the Phosphors

Various concentrations of the phosphors prepared in accordance with Example 1 or the phosphors coated in Example 2 are prepared in silicone resin OE 6550 from Dow Corning by mixing 5 ml of components A and 5 ml of components B of the silicone with identical amounts of the phosphor, so that the following silicone/phosphor mixing ratios are present after combination of the two dispersions A and B by homogenisation using a Speedmixer:

5% by weight of phosphor,
10% by weight of phosphor,
15% by weight of phosphor and
30% by weight of phosphor.

These mixtures are each transferred into an Essemtek dispenser and introduced into empty LED-3528 packages from Mimaki Electronics. After the silicone has cured at 150° C. for 1 h, the light properties of the LEDs are characterised with the aid of a set-up consisting of components from Instrument Systems: CAS 140 spectrometer and ISP 250 integration sphere. For the measurement, the LEDs are contacted with a current strength of 20 mA at room temperature using an adjustable current source from Keithley. The luminance (in lumens of the converted LED/mW optical output of the blue LED chip) against colour point CIE x of the converted LED is plotted as a function of the phosphor use concentration in the silicone (5, 10, 15 and 30% by weight).

The lumen equivalent is a lighting quantity, familiar to the person skilled in the art, with the unit lm/W which describes the magnitude of the photometric luminous flux in lumens of a light source at a certain radiometric radiation power with the unit watt. The higher the lumen equivalent, the more efficient a light source.

The lumen is a photometric lighting quantity, familiar to the person skilled in the art, which describes the luminous flux of a light source, which is a measure of the total visible radiation emitted by a radiation source. The greater the luminous flux, the brighter the light source appears to the observer.

CIE x and CIE y stand for the coordinates in the standard CIE colour chart (here standard observer 1931), familiar to the person skilled in the art, by means of which the colour of a light source is described.

All the quantities mentioned above are calculated from emission spectra of the light source by methods familiar to the person skilled in the art.

### DESCRIPTION OF THE FIGURES

FIG. 1: Powder X-ray diffraction pattern of Example 1a, measured on a StadiP 611 KL transmission powder X-ray diffractometer from Stoe & Cie. GmbH, Cu-Kα1 radiation, germanium [111] focusing primary ray monochromator, linear PSD detector.

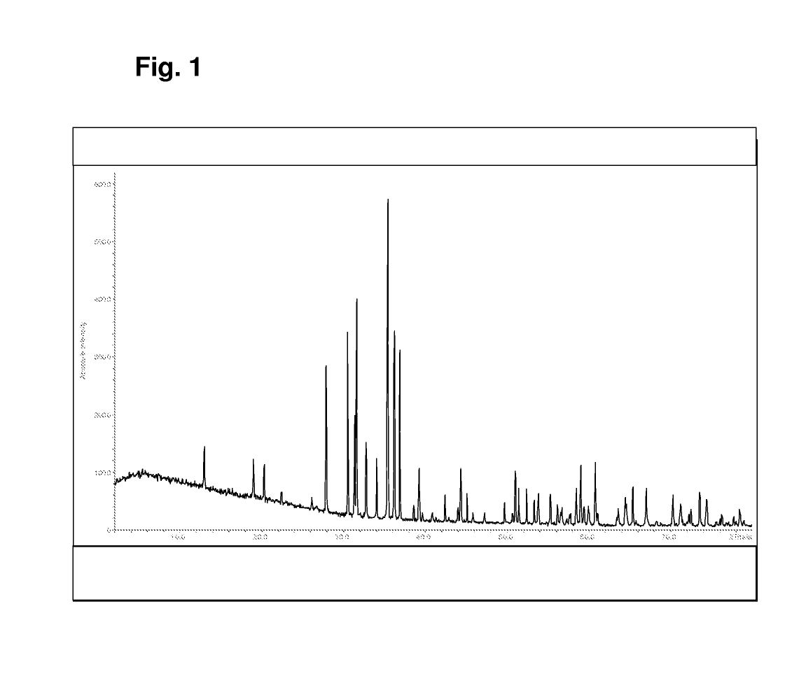

FIG. 2: Fluorescence spectrum of the product from Example 1a, recorded using an Edinburgh Instruments FS920 spectrometer at an excitation wavelength of 450 nm (peak wavelength: 525 nm). In the fluorescence measurement, the excitation monochromator is adjusted to the excitation wavelength, and the detector monochromator arranged after the sample is scanned between 467 and 850 nm in 1 nm steps, with the light intensity passing through the detector monochromator being measured.

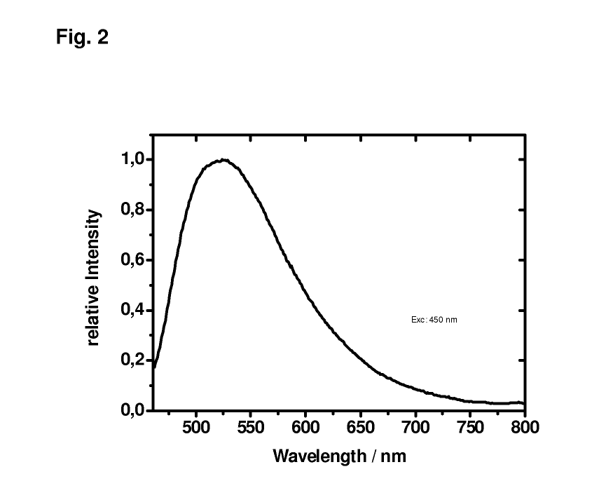

FIG. 3: Excitation spectrum of the product from Example 1a, recorded using an Edinburgh Instruments FS920 spectrometer. In the excitation measurement, the excitation monochromator is scanned between 250 nm and 500 nm in 1 nm steps, while the fluorescent light from the sample is detected constantly at a wavelength of 525 nm.

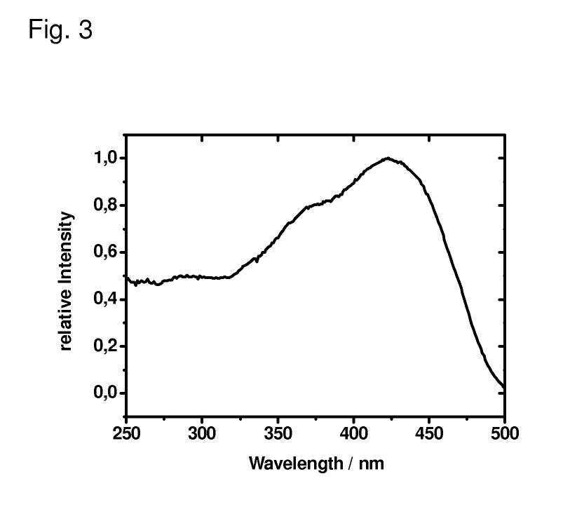

FIG. 4: Fluorescence spectrum of the product from Example 1 b: Sr_{1.764}Ce_{0.04}Eu_{0.005}Li_{0.04}Si₅N_{7.7}O_{0.3}, recorded using an Edinburgh Instruments FS920 spectrometer at an excitation wavelength of 450 nm (peak wavelength: 540 nm). In the fluorescence measurement, the excitation monochromator is adjusted to the excitation wavelength, and the detector monochromator arranged after the sample is scanned between 467 and 850 nm in 1 nm steps, with the light intensity passing through the detector monochromator being measured.

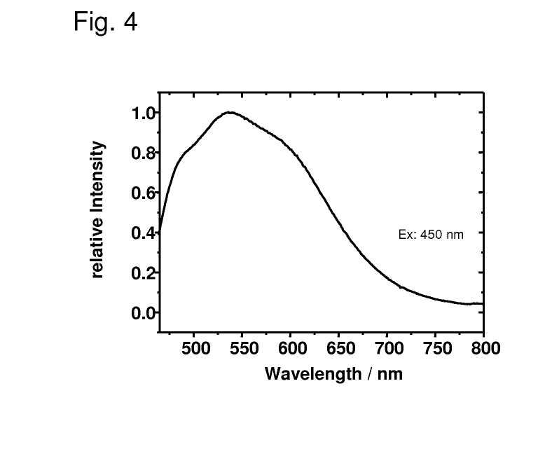

1. Compound containing an anionic skeleton structure, dopants and cations, where
a. the anionic skeleton structure is characterised by coordination tetrahedra GL₄_{^{−}}, where G stands for silicon, which may be partly replaced by C, Ge, B, Al or In, and L stands for N and O, with the proviso that N makes up at least 60 atom-% of L,
b. the cations are selected from the alkaline-earth metals, with the proviso that strontium and barium together make up 50 atom-% of the cations or more,
c. the dopant present is trivalent cerium or a mixture of trivalent cerium and divalent europium,
d. the charge compensation of the cerium doping takes place i) via corresponding replacement of alkaline-earth metal cations by alkali-metal cations and/or ii) via a corresponding increase in the nitrogen content and/or iii) via a corresponding reduction in the alkaline-earth metal cations.

2. Compound according to claim 1, characterised in that the alkaline-earth metal cations are strontium, magnesium, calcium and/or barium, where in one embodiment essentially only strontium and barium are present, and in the same or an alternative embodiment strontium makes up more than 50 atom-% of the alkaline-earth metal cations, and in the same or a further alternative embodiment barium makes up from 40 atom-% to 50 atom-% of the alkaline-earth metal cations.

3. Compound according to claim 1, characterised in that G stands for more than 80 atom-% of silicon or G stands for more than 90 atom-% of silicon.

4. Compound according to claim 1, characterised in that silicon has been partly replaced by C or Ge.

5. Compound according to claim 1, characterised in that G is formed by silicon.

6. Compound according to claim 1, characterised in that it is a compound of the formula Ia,
A_{2-0.5y-x+1.5z}M_{0.5x}Ce_{0.5x}G₅N_{8-y+z}O_{y} (Ia)
where
A stands for one or more elements selected from Ca, Sr, Ba, Mg,
M stands for one or more elements selected from Li, Na, K,
G stands for Si, which may be partly replaced by C, Ge, B, Al or In,
x stands for a value from the range from 0.005 to 1 and
y stands for a value from the range from 0.01 to 3 and
z stands for a value from the range from 0 to 3.

7. Compound according to claim 1, characterised in that it is a compound of the formula Ib,
A_{2-0.5y-0.75x+1.5z}Ce_{0.5x}G₅N_{8-y+z}O_{y} (Ib)
where
A stands for one or more elements selected from Ca, Sr, Ba, Mg,
M stands for one or more elements selected from Li, Na, K,
G stands for Si, which may be partly replaced by C, Ge, B, Al or In,
x stands for a value from the range from 0.005 to 1 and
y stands for a value from the range from 0.01 to 3 and
z stands for a value from the range from 0 to 3.

8. Compound according to claim 1, characterised in that the phosphor is a compound of the formula Ic,
A_{2-0.5y+1.5z}Ce_{0.5x}G₅N_{8+0.5x-y+z}O_{y} (Ic)
where
A stands for one or more elements selected from Ca, Sr, Ba, Mg,
M stands for one or more elements selected from Li, Na, K,
G stands for Si, which may be partly replaced by C, Ge, B, Al or In,
x stands for a value from the range from 0.005 to 1 and
y stands for a value from the range from 0.01 to 3 and
z stands for a value from the range from 0 to 3.

9. Compound according to claim 6, characterised in that x stands for a value from the range from 0.01 to 0.8, alternatively from the range 0.02 to 0.7 and furthermore alternatively from the range 0.05 to 0.6.

10. Compound according to claim 6, characterised in that y stands for a value from the range from 0.1 to 2.5, preferably from the range 0.2 to 2 and especially preferably from the range 0.22 to 1.8.

11. Compound according to claim 1, characterised in that europium is present in the dopant, and the cations contain a proportion of barium.

12. Compound according to claim 1, characterised in that the compound is in the form of a mixture with a silicon- and oxygen-containing compound.

13. Process for the preparation of a compound according to claim 1, characterised in that, in a step a), suitable starting materials selected from binary nitrides, halides and oxides or corresponding reactive forms thereto are mixed, and, in a step b), the mixture is thermally treated under non-oxidising conditions.

14. A method which comprises including a compound according to claim 1 as phosphor in a light source.

15. Light source having at least one primary light source, characterised in that the light source comprises at least one compound according to claim 1.

16. Light source according to claim 15, characterised in that the light source comprises a red-emitting phosphor.

17. Lighting unit, in particular for the backlighting of display devices, characterised in that it comprises at least one light source according to claim 15.

18. Display device, in particular liquid-crystal display device (LC display), with backlighting, characterised in that it comprises at least one lighting unit according to claim 17.

19. A method which comprises including a compound according to claim 1 for the partial or complete conversion of the blue or near-UV emission from a primary light source, preferably a luminescent diode or a laser, into light in the green spectral region.
